(19) United States
(12) Patent Application Publication
(10) Pub. No.: US 2018/0126488 A1
(43) Pub. Date: May 10, 2018

(54) FIBRE OPTIC LASER MACHINING EQUIPMENT FOR ETCHING GROOVES FORMING INCIPIENT CRACKS

(71) Applicant: ROFIN-LASAG AG, Thun (CH)

(72) Inventors: Ulrich DUERR, Allmendingen (CH); Rudolf Von Niederhaeusern, Tschingel ob Gunten (CH); Bruno Frei, Thierachern (CH)

(73) Assignee: ROFIN-LASAG AG, Thun (CH)

(21) Appl. No.: 15/811,358

(22) Filed: Nov. 13, 2017

Related U.S. Application Data
(62) Division of application No. 13/699,392, filed on Feb. 28, 2013, now abandoned.

(30) Foreign Application Priority Data
May 25, 2010 (EP) 10163787.4

(51) Int. Cl. B23K 26/0622

(52) U.S. Cl. CPC B23K 26/0624; B41M 5/24

(57) ABSTRACT

The laser machining equipment for etching grooves in a wall of a mechanical part, in particular of a connecting rod for a spark ignition engine, is provided with a fibre optic laser device and arranged to supply laser pulses. The fibre optic laser device is controlled so that said laser pulses have a peak power of more than 400 W and at least two times greater than the maximum mean power of said laser device and in that the duration of said laser pulses is below or within the nanosecond range (1 ns to 1000 ns). According to a first embodiment, the fibre optic laser device is controlled in a quasi continuous wave (QCW) mode. According to a second preferred embodiment, the fibre optic laser device is controlled in a Q-switch mode. The selected operating modes increase machining efficiency and produce a groove with an optimum transverse profile, particularly with a small mean radius of curvature at the bottom of the groove which then allows precise subsequent fracturing of the mechanical part with less force.

### CROSS REFERENCE TO RELATED APPLICATIONS

The present application is a divisional of U.S. application Ser. No. 13/699,392, filed Feb. 28, 2013, which is based on PCT/EP2011/058254 filed Apr. 20, 2011, and claims priority to European Patent Application 10163787.4, filed May 25, 2010, the entire contents of each of which being incorporated herein by reference.

### FIELD OF THE INVENTION

The present invention concerns the field of laser machining of grooves in a wall or a surface of a mechanical part to define incipient cracks for fracturing said mechanical part into at least two pieces. In particular, the machined mechanical part is a connecting rod for a spark ignition engine. These connecting rods have a main aperture and are initially formed of a single part. Two diametrically opposite grooves are etched into the circular lateral wall of the main aperture. Then, using mechanical means, the connecting rod is fractured into two pieces by pressure. This technique is well known to those skilled in the art.

The use of a laser beam for etching the grooves forming incipient cracks has numerous advantages. In particular, laser technology can be used to make a relatively narrow and deep slot resulting in a clean fracture along a plane containing the central geometrical axis of the main aperture of the connecting rod.

### BACKGROUND OF THE INVENTION

A fibre optic laser machining equipment is known, in particular from DE Patent No. 10 2007 053 814. As mentioned in paragraphs 3 and 4 of that document, various types of laser have been used for the specific application concerned, but the profile of the grooves obtained is not optimum. The quality of the machined grooves is a decisive factor for obtaining a clean fracture along a determined geometrical plane and also for fracturing with less force. The aforementioned German Patent document proposes the use of a particular type of laser device in the machining equipment, namely a fibre optic laser. Preferably, the fibre optic laser includes a set of diodes for pumping the active medium (doped fibre). The use of a diode pumping means increases the frequency of the pulses supplied by the laser device in the proposed pulsed mode. According to paragraph 31 of DE Patent No. 10 2007 053 814, the set of diodes forming the pumping means operates in a pulsed manner. The frequency of the laser pulses produced may be located within a working range of between 10 and 100 kHz. This prior art document therefore proposes using a fibre optic laser operating in pulsed mode, i.e. a mode where the pumping means is powered in a pulsed manner to modulate the laser beam generated at the laser device output. Thus, the pulsed mode consists in modulating the continuous power (CW) of the laser so that the maximum pulse power is equal to the CW of the laser (maximum mean power).

The laser device proposed in DE Patent No. 10 2007 053 814 cannot produce grooves with a sufficiently optimum profile. The use of a fibre optic laser is an advantageous solution for obtaining a good quality laser beam, required for machining a narrow, deep groove. Indeed, a fibre optic laser can produce a high quality laser beam which does not deteriorate during propagation in a low mode fibre optic (preferably single mode) to the machining head of the laser machining equipment. However, the pulsed mode proposed in the aforementioned Patent document greatly limits the potential resulting from the use of a fibre optic laser, in particular as regards the depth/width ratio of the groove, the metallurgic quality of the walls and the radius at the bottom of the groove.

It is an object of the present invention to improve the method of machining grooves forming incipient cracks by proposing a laser equipment that can decrease stray thermal stresses which have several damaging consequences for forming a groove and in the area surrounding said groove (such as the transformation of the metallurgic structure in both walls of the groove and the appearance of micro-fissures in the walls). It is another object of the present invention to increase the efficiency of machining grooves in the lateral wall of connecting rods by allowing the use of a simplified equipment and/or an equipment that can increase machining speed and/or limit the movements of the machining head for machining two diametrically opposite grooves in the main aperture of a connecting rod.

### SUMMARY OF THE INVENTION

In developing the laser machining equipment according to the present invention, the inventors observed that a fibre optic laser device operating in pulsed mode could not provide a groove with a profile having a small ratio between the width and depth of the groove as well as a small radius at the bottom of the groove, which is a decisive factor for decreasing the force required to fracture the mechanical part and also to ensure a fracture in the defined geometrical plane. The disadvantage of the laser device proposed in the aforementioned prior art document mainly arises from two drawbacks of the proposed operating mode. First of all, the proposed pulsed mode only modulates the generated laser beam to supply pulses with a maximum power or peak power equal to the CW that the laser can supply. In the aforecited prior art document, the pulse power is comprised between 10 and 100 Wafts (W), and preferably between 40 and 60 W. For large connecting rods, it is proposed to use more powerful lasers supplying a peak power of around 200 W. (It should be noted that higher power CW lasers exist but they are not economically viable in the industry). It will be noted that in a pulsed mode such as that proposed in the aforecited prior art document, very powerful lasers, at the limits of current industrial laser technology, have to be used to obtain pulses with a peak power of around 200 W.

Laser pulses with a maximum power substantially equal to 200 W or less, with a relatively long pulse duration for providing sufficient energy for the ablation of material, mostly cause the material forming the machined mechanical part to melt. This melted material causes a problem as regards obtaining a good quality groove. In particular, the material has to be evacuated using a high-pressure gas jet. The melted material also causes a problem as regards the cleanness of the groove and the machined surface, and the protective glass at the machining head output. Moreover, the melted material and the ejection thereof using pressurised gas limits the reduction in the radius of curvature at the bottom of the groove despite the high quality of the laser beam produced by the fibre optic laser equipment.

Next, another problem caused by the operating mode provided in the aforecited document arises from the fact that the duration of the pulses supplied is generally within the microsecond range (μs), i.e. more than one microsecond. In particular, diodes operating in pulsed mode can supply pulses with a duration of between 5 and 10 microseconds. Contrary to the statement of the aforementioned document, an increase in frequency does not necessarily cause a decrease in the quantity of energy per pulse. The quantity of energy contained in each laser pulse is determined by both the power and the duration of said pulse. A high frequency certainly generally leads to a decrease in pulse duration for a given mean power, but the pulsed mode proposed does not allow the pulse duration to be decreased below 1 μs in a conventional equipment; which causes a problem of negative secondary thermal effects. Indeed, the diffusion of heat in the machined material depends upon the pulse duration. The longer the pulse duration, the greater the secondary thermal effects will be, and particularly the more the propagation of thermal energy in the area of the machined groove will increase. This results first of all in an increase in the melted material, which leads to a groove with a larger width and a relative large mean radius of curvature at the bottom of the groove. Thus, although the total energy per pulse is substantially correct with a power of around 100 W and a pulse duration of several microseconds, the profile of the groove obtaineds not optimum.

In developing the invention, the inventors demonstrated that a substantial increase in the peak power of the laser pulses supplied decreases the quantity of melted material by increasing the quantity of sublimed material. Moreover, by increasing the pulse power, it is possible to supply the energy required per pulse with a shorter pulse duration; which decreases the thermal stresses at the periphery of the groove and also decreases the radius of curvature of the bottom thereof.

The present invention therefore concerns a laser machining equipment for etching at least one groove each defining an incipient crack in a lateral wall or surface of a mechanical part, said laser machining equipment being characterized by a fibre optic laser device which is controlled so that the laser pulses supplied have a peak power of more than 400 Watts and at least two times higher than the mean maximum power of the fibre optic laser device used and so that the duration therefore is within the nanosecond (ns) range, i.e. comprised between one and a thousand nanoseconds. Typically, the pulse duration is comprised between 50 ns and 400 ns.

According to a particular embodiment, the fibre optic laser device is controlled in a quasi continuous wave (QCW) mode. A fibre optic laser device controlled in QCW mode can for example produce pulses with a maximum power or peak power ten times higher than the mean maximum power of the laser device.

According to a preferred embodiment, the fibre optic laser device is controlled in a Q switch mode. According to another preferred embodiment, the fibre optic laser device includes a seed laser source (for example a diode supplying pulses within the nanosecond range) and at least one fibre optic amplifier medium supplying the laser machining pulses abutput.

As a result of the features of the invention, it is possible to machine very narrow and relatively deep grooves with a very small radius at the bottom of the groove. The laser pulses supplied by the fibre optic laser device according to the present invention decrease the quantity of melted material and also significantly limit the stray thermal effects responsible for the deterioration in quality of the grooves obtained.

### BRIEF DESCRIPTION OF THE DRAWINGS

The present invention will be described in more detail in the following description, made with reference to the annexed drawings, given by way of non-limiting example, and in which:

FIG. 1 is a schematic view of a connecting rod and a fibre optic laser device associated withal groove machining head;

FIG. 2A shows a schematic perspective view of a groove (partial view) machined using a prior art device.

FIG. 2B is a similar schematic view to that of FIG. 2A but showing a groove obtained using a laser equipment according the present invention.

FIG. 3 is a schematic cross-section of a particular first embodiment of a machining head of a laser equipment according to the present invention.

FIG. 4 is a schematic cross-section of a particular second embodiment of a machining head of a laser equipment according to the present invention.

FIG. 5 is a schematic cross-section of a particular third embodiment of a machining head of a laser equipment according to the present invention.

### DETAILED DESCRIPTION OF THE INVENTION

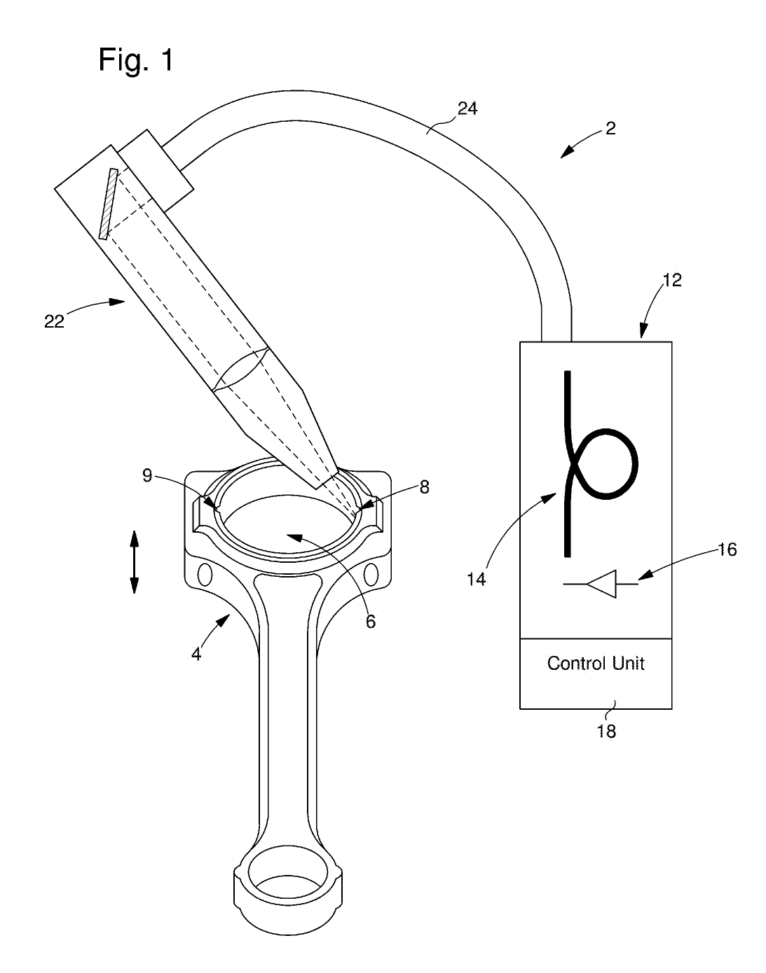

FIG. 1 is a schematic view of a laser machining equipment 2 for making grooves 8 and 9 in the lateral wall of the main aperture 6 of a connecting rod 4. These grooves are oriented along the central geometric axis of the main aperture. The equipment includes a fibre optic laser device 12 connected to a machining head 22 by a flexible optical cable 24. Machining head 22 and connecting rod 4 are associated with a motorised means (not shown) of relative movement along said central geometric axis for etching the grooves. Laser device 12 include an active fibre optic medium 14 known to those skilled in the art and a means 16 of pumping formed of optic diodes coupled to the active medium. This device includes a control unit 18 which controls the powering of the optical pumping means and other parameters according to the selected operating mode. Generally, a series of laser pulses is supplied.

The use of a fibre optic laser has several advantages relating to the quality of the laser beam obtained. Further, the beam can be brought to the machining head by a low mode optical cable while still preserving good optical beam quality, which simplifies the equipment. Beam quality is important to allow proper focusing (even with an incident laser beam on the optical focusing system with a relatively small diameter) and thus to reduce the diameter of the beam at the focal point. This must enable narrow grooves to be formed. However, making a narrow and sufficiently deep groove, with walls defining an acute angle and a small radius at the bottom of the groove, involves parameters other than the beam quality. As mentioned above, controlling the supply of energy and in particular controlling luminous intensity, i.e. the power density, are decisive factors in machining this type of groove with an optimal profile. The manner in which material is ablated in the wall of the connecting rod is essential in achieving this optimum profile.

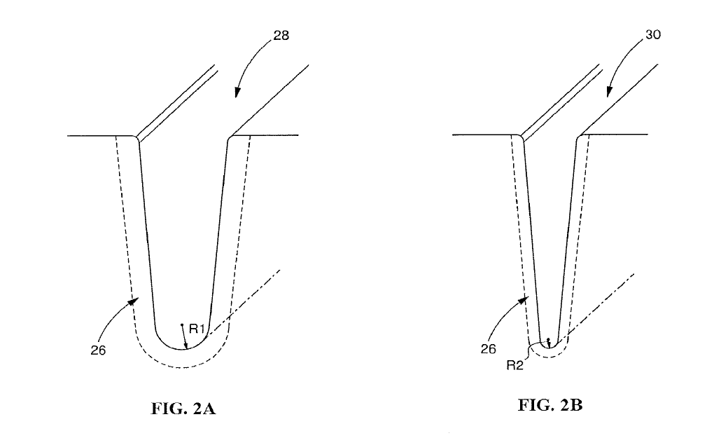

The use of a fibre optic laser device operating in pulsed mode by modulating the pumping power of the active medium, as proposed in the prior art, results in pulses having a peak power equal to the nominal power of the laser, which is generally less than 200 W for an industrial fibre optic laser, and having a duration of more than 1 μs. This relatively low power cannot provide sufficient luminous intensity to prevent a large part of the material receiving the laser pulse from melting and thus changing into a liquid state. The melted liquid material causes a problem of evacuation and tends to remain partly at the bottom of the groove. This results in a relatively large mean radius of curvature R1 at the bottom of the groove, as is shown schematically in FIG. 2A. Further, the relatively long duration of the pulses also generates secondary thermal effects or thermal stresses in the material, as the thermal energy propagates further into the peripheral region 26 of the machined groove 28. Therefore, the melted material, the quantity of energy provided by each laser pulse and the duration of each pulse all contribute to widening the groove and producing a relatively large mean radius R1 at the bottom of the groove.

The findings brought to light in developing the invention result in the selection of a particular control of the fibre optic laser device. According to the invention, the fibre optic laser device is controlled so that the laser pulses have a peak power of more than 400 W and at least two times greater than the maximum mean power of the laser device and so that the duration of the laser pulses is within the nanosecond range (ns), i.e. between 1 ns and 1000 ns or below.

According to a first operating mode of the fibre optic laser device according to the present invention, this laser device is controlled in a quasi continuous wave (QCW) mode. For a laser with a power of between 50 W and 150 W, it is easy to obtain pulses with a peak power of around 1000 W (1 kW). Depending upon the variant and the application, the laser device is arranged to obtain a peak power or maximum pulse power of between 400 W and around 3000 W (3 kW). Those skilled in the art of fibre optic lasers know how to implement QCW mode and the specific diodes required to obtain such laser pulses.

To obtain short pulses within the nanosecond range, in particular between 50 ns and 400 ns, with very high power peaks, two main variants described below were envisaged.

According to a second operating mode, the fibre optic laser device is controlled in a Q-Switch mode. This second operating mode is preferred since it advantageously obtains significant shorter pulse durations than the QCW mode of the first operating mode proposed and also much higher peak powers, for example of around 10 kW. It is therefore possible to obtain very high luminous intensities for sublimating the material of the machined mechanical C part, i.e. to change directly from a solid state to a gaseous state. For example, the fibre optic laser device is controlled so as to supply the laser pulses with a frequency of between 10 kHz and 200 kHz. Since the duration of the pulses is very short, the quantity of energy supplied per pulse is also limited. This quantity of energy may be adjusted to optimise the laser machining method according to the present invention, particularly between 0.1 mJ and 2 mJ. Since the duration of the pulses is very short, the secondary thermal effects and penetration of thermal energy into the material is greatly limited. This allows a very narrow and relative deep groove to be obtained with an optimal profile, as shown schematically in FIG. 2B. The perforations made are narrower than those obtained in the prior art. The width/depth ratio of the machined groove 30 is lower than that obtained with a prior art laser device and the mean radius of curvature R2 at the bottom of the groove is significantly lower than that (R1) of FIG. 2A. This all results in a clean groove with a minimum of material ejected onto the wall of the opening at the edge of the groove and also in an improved incipient crack for the subsequent fracturing of the mechanical part into two pieces.

According to a third embodiment which is also preferred, the fibre optic laser device includes a seed laser source and at least one fibre optic amplifier medium supplying the laser machining pulses at output. The seed laser pulses form low power pulses that can be produced with a very short duration and at a very high frequency, for example at 10 MHz. These seed pulses are introduced into the input of the fibre optic amplifier medium which substantially maintains the duration and also the frequency of the seed pulses and which greatly amplifies the pulse power. This means of amplification can easily obtain peak powers of more than 1000 W. Those skilled in the art know how to construct this type of fibre optic laser device.

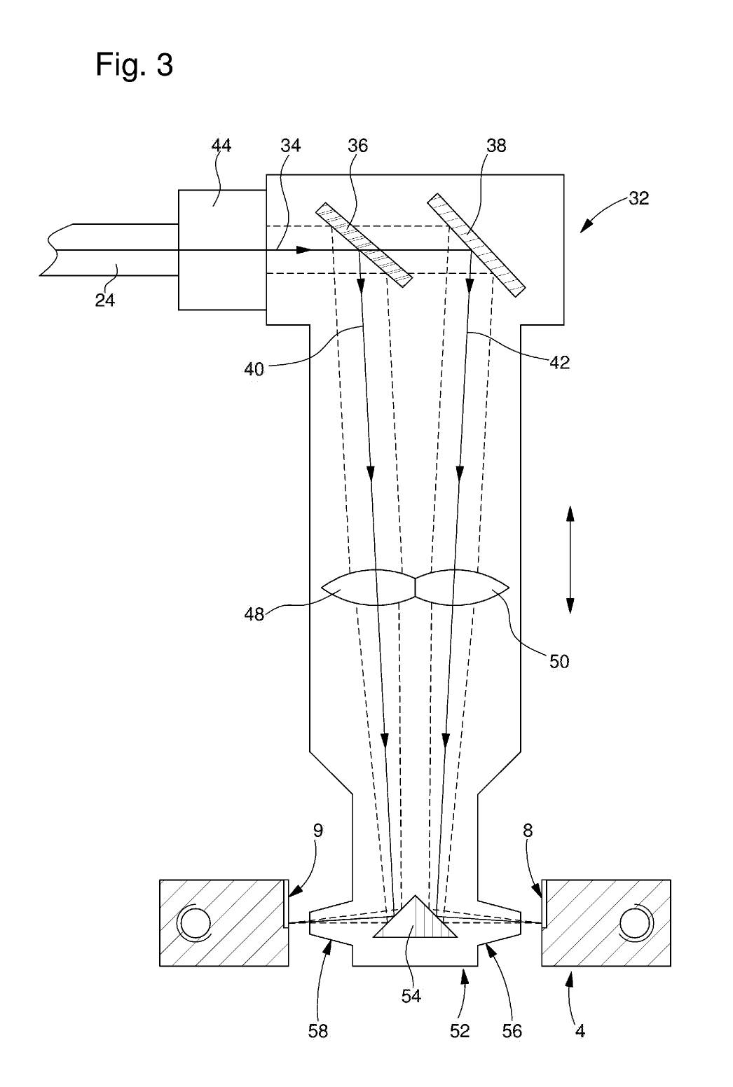

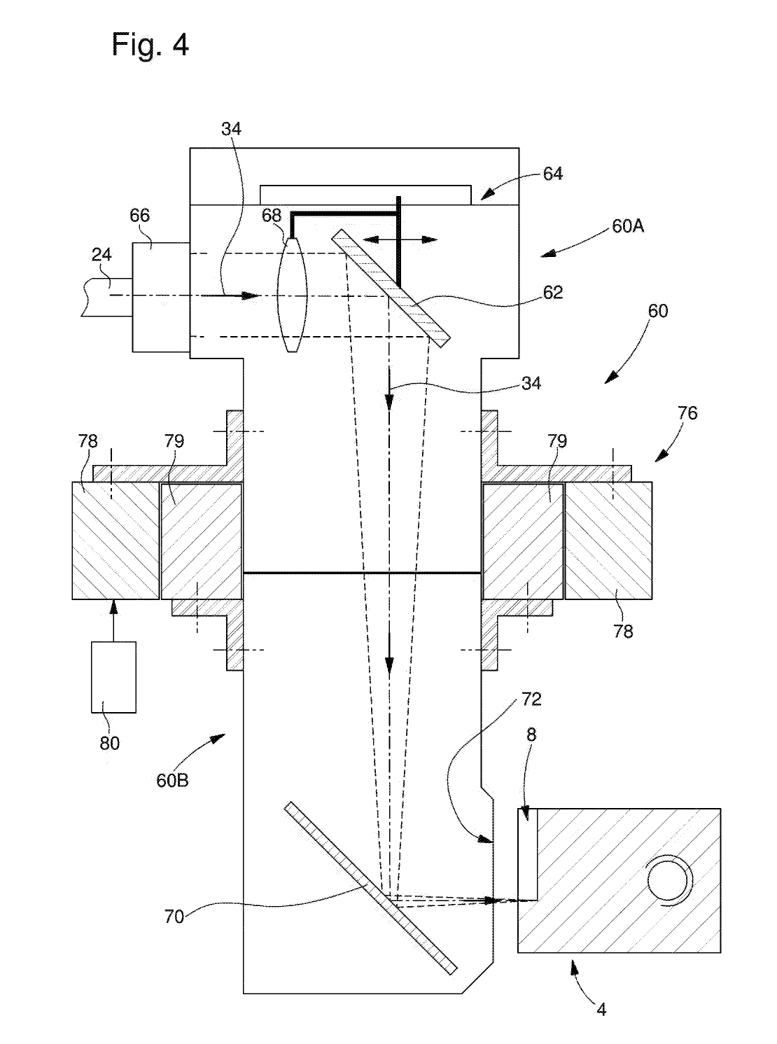

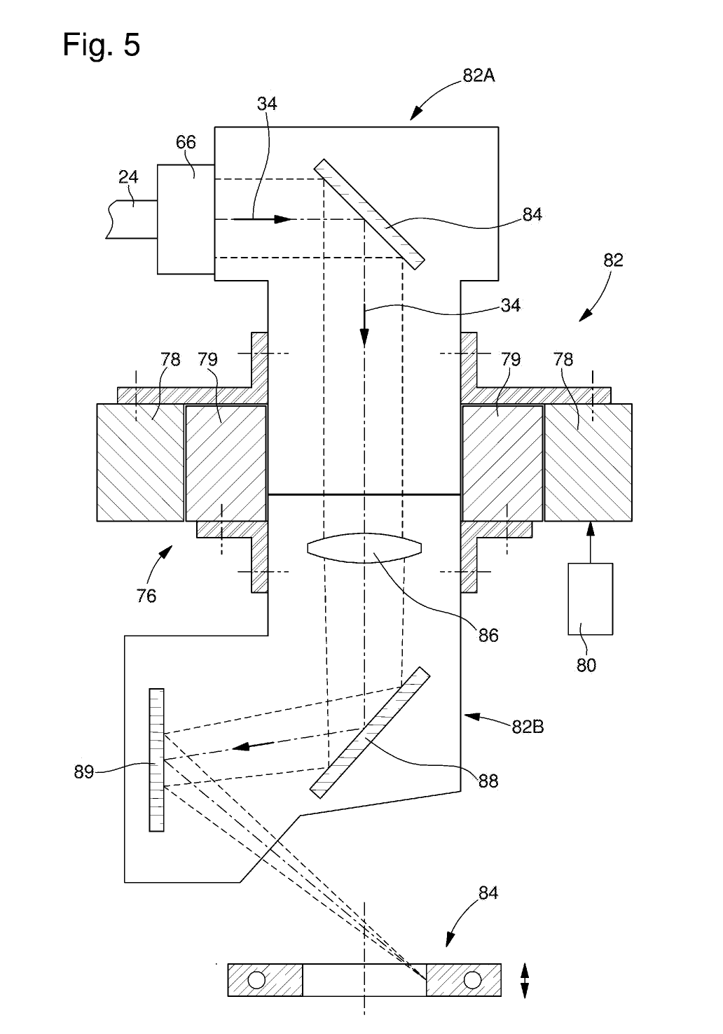

The machining method according to the invention and the laser machining equipment for implementing said method have further advantages. First of all, the generation of very high power pulses makes it possible to envisage simultaneously machining two diametrically opposite grooves in a connecting rod, in particular by dividing the energy from each primary laser pulse into two secondary pulses, the power of which is half that of said primary laser pulse, while keeping the other benefits of the invention. A particular machining head shown in FIG. 3 is a particular embodiment using this additional advantage. Secondly, since the melted material is greatly limited or eliminated in the laser equipment according to the invention, the use of a high pressure gas as in the prior art is no longer necessary. Thus, there is no longer a requirement to use nozzles with a small orifice for injecting the high pressure gas at the place of impact of the laser beam onto the wall of the machined mechanical part. Gas may, however, continue to be used in order to keep the machining head clean, but this gas may be a low pressure gas and extend over a wider area. Two particular machining heads shown respectively in FIGS. 4 and 5 are embodiments which benefit from this additional advantage.

Machining head 32 shown in FIG. 3 is connected to optical cable 24 and receives at input a laser beam 34 formed of laser pulses according to the invention. The input of this machining head further includes a collimator 44 for the laser beam exiting the fibre optic with a large aperture, a first semi-transparent mirror used to divide primary beam 34 into two secondary beams 40 and 42 and a second mirror 38 for reflecting secondary beam 42 in a substantially axial direction. Each of the two secondary beams is associated with an optical focusing means schematically represented by a convex lens 48 and 50 respectively, to focus these two secondary beams on the lateral wall of connecting rod 4. To adjust the respective focal points of the two secondary beams, lenses 48 and 50 may preferably be moved vertically. It will be noted that, owing to the high quality of the laser beam produced by the fibre optic laser, very good focussing can be obtained with an incident laser beam on the relatively small diameter focussing means. Thus, the convex lenses may have a relatively small diameter and the head can maintain a compact form. The end portion 52 of the machining head introduced into the aperture in connecting rod 4 includes a mirror 54 with two inclined reflective surfaces for deviating the two secondary beams in a substantially perpendicular direction to the lateral surface of the aperture of the connecting rod and respectively in two opposite directions for simultaneously machining two diametrically opposite grooves 8 and 9. The two secondary laser beams exit the end portion 52 respectively through two diametrically opposite end apertures, defined by the orifices of two nozzles 56 and 58, propagating in the same geometrical plane. In a variant, the reflective surfaces of the prismatic mirror 54 each have a inclination which reflects the secondary incident beam obliquely to the machined lateral surface. In a known manner, a gas may be provided inside the machining head and exit through these two conventional nozzles. A single relative vertical movement between connecting rod 4 and machining head 32 enables the two grooves 8 and 9 to be machined in parallel.

Machining head 60 shown in FIG. 4 is connected to optical cable 24 and receives at input a laser beam 34 formed of laser pulses according to the invention. The input of this machining head includes a collimator 66 for the laser beam exiting the fibre optic with a large aperture, a removable mirror 62 associated with motorised means 64 allowing a linear movement of said mirror 62 which reflects the beam in a parallel direction to the longitudinal axis of the machining head, and a focusing means 68 (represented by a convex lens) integral with the removable mirror. It will be noted that in a variant, the focusing means is advantageously arranged after the removable mirror, closer to the machined lateral surface. Preferably, the focusing means can be moved relative to mirror 62 to adjust the position of the focal point. Finally, the beam ends up on an inclined mirror 70 arranged at the end of the machining head. This mirror 70 is oriented so that the plane of incidence of the laser beam is parallel to the direction of movement of mirror 62. The beam reflected by mirror 70 exits the head through an end slot 72 the height of which is at least equal to the length of groove 8, i.e. equal to or slightly greater than the height of the connecting rod. By moving, removable mirror 62 causes the laser beam to make a vertical sweep of the wall of the aperture of connecting rod 4. Thus the beam gradually moves along end slot 72 to machine groove 8 without any relative vertical movement between machining head 60 and connecting rod 4. The machining head is therefore held in a fixed position during the laser machining of a groove. The end slot does not cause any particular problem here since no high pressure gas is used for evacuating melted material. However, a low pressure gas may be injected through slot 72 to protect the protective glass arranged in the vicinity of said slot. In a variant, a gas jet is injected between the wall of the connecting rod and the end slot from above or below depending on the direction of machining. The machining head is formed in two parts 60A and 60b, the top part 60A being fixed (or able to move in a horizontal linear direction) and the bottom part 60B being able to rotate to allow the diametrically opposite groove to be machined without having to rotate the top part connected to the optical cable. To rotate the bottom part, a torque motor 76 is arranged with the stator part 78 thereof connected to the fixed part 60A and the rotor part 79 thereof connected to the rotating part 60B. This motor has a central opening for the laser beam to pass through and is actuated by a programmable control unit 80 used to provide it with electric power.

FIG. 5 shows another embodiment of a machining head 82 according to the invention. This head comprises a top part 82A which can undergo a vertical movement and a bottom part 82B which can also undergo a rotation. A torque motor 76 described above is arranged for rotating the bottom part so as to allow two diametrically opposite grooves to be machined without having to 3o rotate the top part 82A connected to optical cable 24. At the optical cable output there is arranged a means 66 of collimating the incoming laser beam, which is incident on a mirror 84 arranged obliquely to reflect the laser beam 34 in an axial direction. The bottom part 82B includes an objective lens 86 which can be moved vertically to adjust the focal point, a first oblique mirror 88 and a second mirror 89 finally reflecting the beam obliquely. The exit angle of the laser beam can be varied according to the orientation of mirrors 88 and 89. This particular arrangement can produce two diametrically opposite grooves in small apertures, without having to move the top part 82A of the machining head. Thus, the optical axis of this top part merges with the central axis of the aperture of mechanical part 84. A specific bottom part can be provided for each different diameter. Preferably, the vertical position of lens 86 can be adjusted in order to adjust the focal point according to the diameter of the connecting rod. It will be noted that the bottom part 82B of the machining head is located entirely above the part to be machined 84. This is made possible by the fact that the method according to the invention does not require a gas for ejecting melted material in the groove being formed and the proportional quality factor in M² is sufficiently small to have a small focal point relatively far away from the focusing means to make a groove. There is either a relative vertical movement between part 84 and the machining head 82 or a scan is made by varying the position of at least one of the two mirrors 88 and 89.

1. A method of etching at least one groove in a lateral wall or surface of a mechanical part by laser pulses supplied by a fiber optic laser device, the groove defining an incipient crack for subsequent fracturing of the mechanical part into at least two pieces, the method comprising:
controlling the fiber optic laser device so that the laser pulses have a peak power of more than 400 W and at least two times greater than the mean maximum power of the laser device, and
wherein a duration of the laser pulses is below or within the nanosecond range of 1 ns to 1000 ns.

2. The etching method according to claim 1, wherein the fiber optic laser device operates in a quasi continuous wave mode.

3. The etching method according to claim 2, wherein the laser pulses have a peak power of between 400 W and 3000 W.

4. The etching method according to claim 1, wherein the fiber optic laser device is operated in a Q-switch mode.

5. The etching method according to claim 1, wherein the fiber optic laser device includes a seed laser source and at least one fiber optic amplifier medium supplying the laser pulses at an output.

6. The etching method according to claim 4, wherein the laser device is controlled so that the duration of the laser pulses is between 50 ns and 400 ns.

7. The etching method according to claim 4, wherein the fiber optic laser device is controlled so as to supply the laser pulses with a peak power of more than 1000 W.

8. The etching method according to claim 4, wherein the fiber optic laser device is controlled so as to supply the laser pulses with a frequency of between 10 kHz and 200 kHz.

9. The etching method according to claim 1, wherein a low mode optical cable is provided between the laser device and a machining head to which the laser pulses are supplied.

10. The etching method according to claim 1, wherein the mechanical part is a connecting rod in a main aperture of which two diametrically opposite grooves are simultaneously etched.

11. The etching method according to claim 4, wherein the laser device is controlled so that the duration of the laser pulses is between 50 ns and 400 ns.

12. The etching method according to claim 5, wherein the fiber optic laser device is controlled so as to supply the laser pulses with a peak power of more than 1000 W.

13. The etching method according to claim 5, wherein the fiber optic laser device is controlled so as to supply the laser pulses with a frequency of between 10 kHz and 200 kHz.
